(19) United States
(12) Patent Application Publication
(10) Pub. No.: US 2019/0228633 A1
(43) Pub. Date: Jul. 25, 2019

(54) Fall Warning For A User

(71) Applicant: Continyou AS, Sandnes (NO)

(72) Inventors: Terje Tobiassen, Kleppe (NO); Glenn Arild Haugland, Randaberg (NO)

(21) Appl. No.: 16/327,746

(22) PCT Filed: Aug. 24, 2017
(86) PCT No.: PCT/EP2017/071321

§ 371 Date: Feb. 22, 2019

(30) Foreign Application Priority Data
Aug. 25, 2016 (EP) 16185603.4

(51) Int. Cl. G08B 21/04

(52) U.S. Cl. CPC G08B 21/0446; G08B 21/0453

(57) ABSTRACT

The invention relates to a method for fall warning. The method is performed by a wearable device and comprises measuring at least one physiological parameter of a user wearing the wearable device, predicting a fall of the user, by comparing the measured at least one physiological parameter with at least one threshold, warning the user when a fall is predicted, receiving an indication of a fall or of not a fall, and adjusting the threshold based on the received indication. A wearable device, a computer program, and a computer program product for fall warning are also presented.

### TECHNICAL FIELD

The invention relates to a method for fall warning for a user, and a wearable device, a computer program and a computer program product thereof.

### BACKGROUND

Certain health issues or conditions such as epilepsy, dementia, anxiety, or simply high age may cause unforeseen incidents such as falls or panic attacks. For instance, for an elderly person, a fall could be a very serious incident, sometimes even fatal. The impact of the fall itself can cause injuries, especially to elderly people. The consequence of e.g. a hip fracture can in some cases be terminal. Also without a major impact, a situation can occur where the fallen person cannot get up again, wherein the person is exposed to e.g. low temperatures, which can also lead to death. Many elderly people therefore live in a continuous state of anxiety, where they feel unsafe even in their own home.

Falls can be sudden without any other cause than balance problems, or it can be as a consequence of a health issue. In the first case, the important action is to alert someone who can assist. In the second case, there may be opportunities to avoid the fall or at least reduce the impact of the fall.

The root cause of the fall can in some cases lead to loss of consciousness, and this loss of consciousness becomes the cause of the actual fall. However, in some cases the person is in a situation where even larger consequences than a fall can occur. E.g. if the person is driving a car, flying an aeroplane or other activity, the loss of consciousness can have adverse effects on third parties or property and/or equipment.

Another well-known problem is people suffering from dementia, who may wander off out of their home or nursing home without proper clothing and oftentimes unable to find their way back. Not only is this dangerous for the actual person getting lost, it is also causing a lot of distress for the relatives and costs both time and money for the emergency services which are called out to search for the person.

There are prior art safety alarms for instance as a tool for elderly people to call for help if they fall or in other ways have gotten into a situation where they need assistance. The most common solution for this kind of problem is a wearable safety alarm having a button which the user has to press whenever assistance is needed. This method works well as long as the user is conscious and capable of pressing a button. Also this method is limited to situations where the person is within reach of the security alarm system in their home.

There are also devices which automatically cause an alarm in case the user falls or has an epileptic seizure or the like.

One example of a known device is the epilepsy alarm “EPImobile” from Abilia AS, described on:

http://www.abilia.com/sites/abilia.com/files/EPImobile_2015_no.pdf
which detects movement of the user's arm in three dimensions and calculates whether the movement is normal or whether it has the character of an epileptic seizure. In case of epileptic seizure the device automatically calls for assistance.

Another example of a known device is the fall detector “Lommy 8A2” which is provided with a shock sensor causing the device to call for help in case the user falls. The device is described on:

http://holars.no/produkt/11440/lommy-8a2-trygghetsalarm-falldetektor-gps-7-knappe/.

A third example of a known device is the fall detector “Cognita Fallofon”, described on: http://www.cognita.no/produkt/20. This fall detector may be used over large distances, as long as both the device which the user carries, and the receiver unit which the care person carries, are within a GSM service area. The device works automatically by registering the fall and contacting the receiver unit.

Common for all known devices is that they register movement and/or shock, and that the alarm goes off after, or at the moment when, the incident happens.

Also, in the health watch marked there is a product called “Doro Secure 480”, described on: http://care.doro.co.uk/produkter/doro-secure-480/. This watch looks like an ordinary wrist watch and it offers two health related functions: GPS tracking and user initiated emergency call to alarm centre or contacts.

US patent application No. 2015/0223705 describes a multipurpose wearable portable device that can collect and process data/information/parameter values from one ore more predefined/threshold values to suggest one or more actions and/or generate alerts/messages/suggestions to be performed by one or a combination of remote system, wearer, home automation network, healthcare provider, doctor, caretaker, among other stakeholder.

### SUMMARY

An object of the present invention presented herein is to provide a user with the possibility to act before a fall occurs.

According to a first aspect a method for fall warning is presented. The method is performed by a wearable device and comprises measuring at least one physiological parameter of a user wearing the wearable device, predicting a fall of the user, by comparing the measured at least one physiological parameter with at least one threshold, warning the user when a fall is predicted, receiving an indication of a fall or of not a fall for the predicted fall, and adjusting the threshold based on the received indication.

By adjusting the threshold(s) the prediction of a fall for the user is improved.

The at least one physiological parameter may comprise blood oxygen saturation and/or heartrate.

The method may comprise measuring a second parameter, different from the at least one physiological parameter of the user, to provide the indication of a fall or not a fall. The second parameter may be a relative barometric pressure.

The method may comprise receiving a list of indications of a fall or of not a fall for a plurality of corresponding predicted falls.

According to a second aspect a wearable device is presented. The wearable device comprises at least one sensor configured to measure at least one physiological parameter of a user wearing the wearable device, a control unit configured to predict a fall of the user, by comparing the measured at least one physiological parameter with a threshold, and a user interface configured to warn the user when a fall is predicted, wherein the control unit is configured to receive an indication of a fall or not a fall for the predicted fall, and to adjust the threshold based on the received indication.

The sensor may be an optical sensor.

The wearable device may comprise a second sensor configured to measure a second parameter, different from the physiological parameter of the user, to provide the indication of a fall or not a fall.

The second sensor may be a relative altitude sensor, measuring a relative barometric pressure.

The control unit may comprise a processor and a computer program product storing instructions that, when executed by the processor, causes the wearable device to measure at least one physiological parameter of a user wearing the wearable device, to predict a fall of the user, by comparing the measured at least one physiological parameter with a threshold, to warn the user when a fall is predicted, to receive an indication of a fall or of not a fall for the predicted fall, and to adjust the threshold based on the received indication.

According to a third aspect a computer program for fall warning is presented. The computer program comprises computer program code which, when run on a wearable device, causes the wearable device to measure at least one physiological parameter of a user wearing the wearable device, to predict a fall of the user, by comparing the measured at least one physiological parameter with a threshold, to warn the user when a fall is predicted, to receive an indication of a fall or of not a fall for the predicted fall, and to adjust the threshold based on the received indication.

According to a fourth aspect a computer program product is presented. The computer program product comprises a computer program and a computer readable storage means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating a wearable device connectable to a network;

FIG. 2 is a schematic diagram illustrating a wearable device connectable to a home network;

FIG. 3 is a schematic block diagram of a wearable device presented herein;

FIGS. 4-8 are flow charts illustrating processes for embodiments presented herein;

FIG. 9 is a schematic diagram illustrating some components of a wearable device presented herein;

FIG. 10 is a schematic diagrams showing functional modules of a wearable device presented herein; and

FIGS. 11A-B are flow charts illustrating methods for embodiments presented herein.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

Falls initiated by health conditions can in many cases be predicted and/or measured at a time when there is still time to take a preventive or corrective action such as sit down, lay down, get fresh air, take a pill, etc. If a person can feel and recognize signs himself predicting a fall, he can take actions accordingly. But there are conditions a person cannot feel, or the person cannot perceive and interpret the signals due to the context or activity the person is in, or due to the state of mind.

The known solutions are not capable of actually preventing the user from falling or warning the person prior to the incident.

The solution of the invention is to provide continuously improving health related safety feedback through a safety feedback system made such that potential incidents can be detected and possibly prevented or at least such that a person can be warned earlier.

It is further a challenge of having a user to wear a device, and to charge the device. Some health devices on the market have a battery operating time of less than a normal day, such that it is not sufficient to only charge the device once per day. In addition, some health conditions of the users will make a barrier towards wearing and charging the device. Some will tend to take it off arbitrarily, some will forget to charge it, and some will forget to put it on after charging. If the device is only partially worn, the value decreases dramatically.

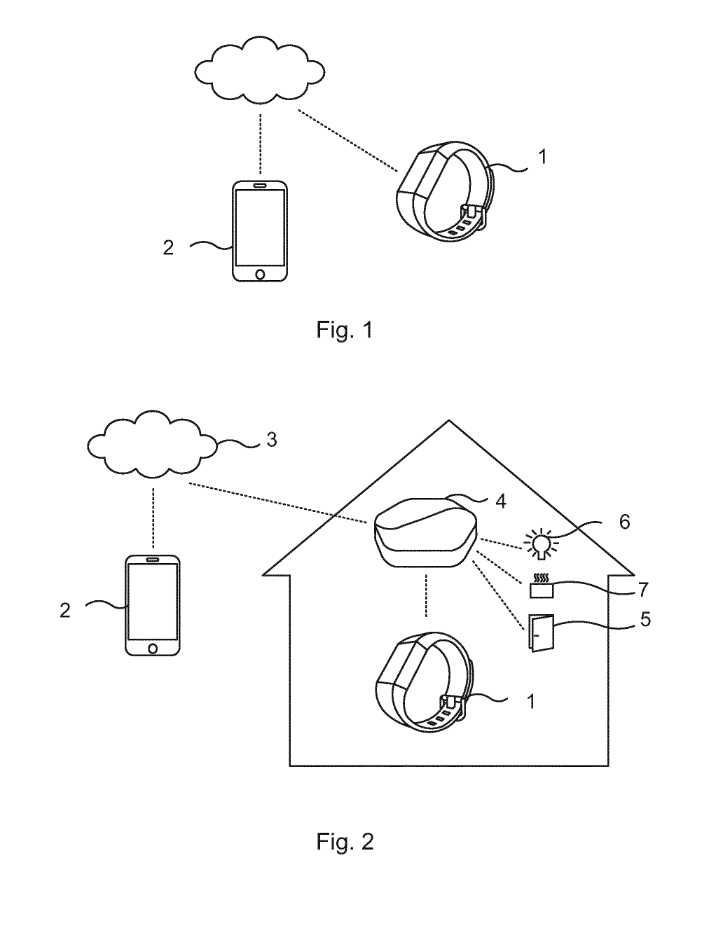

Detection, analyses and feedback may be provided through a wearable/portable device, capable of reading physiological, psychological and context parameters, analysing the input, inform/warn the user of a predicted fall and possibly to alert care persons and others. A psychological parameter may be vertigo which can be interpreted e.g. by evaluating gyroscope and/or accelerometer movements. Other physiological parameters may be migraine, unconsciousness, deliria, anger, anxiety, etc., which may be able to identify by one or more physiological parameter. A wearable device in the form of a watch 1 is illustrated in FIG. 1. The watch 1 can be in connectivity with a mobile device 2, which e.g. may be used by a care person. The connectivity may be through the Internet or through a peer-to-peer connection such as Bluetooth or NFC.

A safety feedback system presented herein comprises a wearable/portable device, for instance in the form of a watch wearable on the wrist of a user. The watch may be provided with one or more sensors for monitoring certain physiological and/or, psychological parameters of the user, depending on the condition of the user, together with context sensors and networked information. For instance, the watch may be provided with sensors for monitoring heart rate, blood oxygen level and/or skin temperature. The device may give a signal to the user whenever one or more of the sensor detected values are above or below a predetermined level, or a combination of sensor detected values, possibly also combined with networked parameters, and/or calculated parameters, provides a pattern or a calculated value which is above or below a threshold value. The signal may be a warning to the user that he or she should take precautions to avoid a potential fall, losing consciousness, etc., e.g. to sit down, take medication, or in any other way try to reduce stress factors in order to prevent an incident from happening. A signal may also be sent to alert a care person in the form of an alarm, a phone call, a SMS, or the like.

The wearable device may be equipped with a barometric pressure sensor of a relative type. This sensor can very accurately measure changes in pressure over time. The resolution and accuracy may be on centimetre level, and it will be used to measure changes in elevation. If the change in elevation is not consistent with the user's current activity or expectation, the wearable device may be configured to determine that a fall has started or occurred.

The wearable device may additionally be provided with a GPS enabling the wearable device to send its location such that the user may easily be found if the incident happens outside of the user's home.

The GPS location can also be used to improve the detection of a fall. E.g. if a sudden increase in pressure happens at a specific location, the likelihood of a fall can be smaller. The specific locations to be used to reduce likelihood of fall can be derived from e.g. GIS system (Geographical Information System) or from a central database of user statistics, where a high percentage of devices are observing rapid pressure increase/decrease, to determine where there are e.g. lifts and escalators

To avoid a user to remove the wearable device, the device can be equipped with locks that will either prevent the user to remove it, or to make it difficult for the user to remove it. A lock which can be controlled by a remote functionality is also presented, controlled e.g. by a caretaker.

To ensure that the wearable device is always charged, the invention may comprise a wireless charging component. A power source can be integrated in a position coinciding with the daily routines of the user, e.g. integrated in a resting chair. In addition, the wearable device may be equipped with a solar cell, even a transparent one, to cover e.g. the display area of the device. The wearable device may also have a kinetic-to-electric converter, wherein the user's activity and movements charges a battery.

The safety feedback system may also comprise more elements, for instance a home controller which may be connected to lighting, heating, door locks and the like in the wearer's home or residence. The home controller may warn the user via the wearable device, or a care person via an application on a phone, if something irregular is detected with regards to for instance the entrance door remaining unlocked for more than a predefined amount of time, or similar irregularities. The safety feedback system may also unlock doors, gates, etc. to allow for emergency entry by paramedics in case emergency or care persons are alerted after e.g. a manual or automatic fall warning. It may also guide the emergency or care persons to find the person. The safety feedback system can contribute to making the daily life of especially elderly people safer.

Furthermore, a safety feedback system is presented wherein wearable device is continuously becoming more and more accurate. A presented embodiment will contribute to establish facts and patterns determining early phases of a potential fall, and utilize this knowledge to improve predictions and alerts for a plurality of users. The safety feedback system may also learn which combinations of measured parameters that should cause an alarm to go off. This may be implemented by providing the possibility to collect data from multiple users connected to the safety feedback system, and to use these data to improve the safety feedback system. This may further be done by sending all data from users to a database, de-personalize it, and use it as input to algorithms and/or analysts which analyse health related events and find e.g. which levels of sensor measured data, patterns in data and combinations of data that are critical. Based on this, updated information can be returned to wearable devices and home controllers, to make them more precise and intelligent.

The effect of this is that the collected information may be used to study the change in measurements in a given period, say 10-15 seconds, prior to an attack or a fall or other relevant situation. This information may then again be sent back to the wearable devices in use with adjusted threshold values for the different measured parameters, such that the next time an alarm may go off sufficiently early, and still sufficiently reliably, for the user to take any necessary precautions.

The wearable device may also be personally adapted to a user and over time learn from individual user patterns, with or without support from the central database.

Connection of many users to the same safety feedback system gives an increased opportunity to quickly and accurately improve the safety feedback system. All data, from all users, may be sent to a central database, de-personalized, and used as input to algorithms which analyse health-related events and determine which levels of sensor measured data are critical. Based on this, the updated information will be returned to the rest of the safety feedback system, for instance to the wearable devices, to make them more precise.

All analysis and calculations methods described herein may be applied on part of, or the full population of, wearable devices connected to the central database. In addition, generic statistical or other analysis methods may be applied to search for unforeseen patterns or correlations, which again can lead to improved algorithms or threshold values. Based on all uploaded verification indications, the safety feedback system may also adjust prediction algorithms and improve reliability/confidence in these predictions.

The safety feedback system may focus a search for relevant patterns/correlations to a more relevant selection of parameters and combinations thereof, for a subset of device users, e.g. sharing the same diagnosis or medication plan.

In the central database, each device user may be registered and managed. More than often, it will be one or more trusted persons who manage this on behalf of the user. This manager may modify personal information and monitor data received from the wearable device, according to permissions granted. For an optimal evaluation and characterization of prediction/detection triggers and patterns, each user may be registered with e.g.:
physical parameters (sex, age, weight, height, etc.),
localizations (language, country, area),
type of health condition/diagnosis,
medication plan, and
monitored illnesses, events.

For each user, it may also be possible to adjust the sensitivity of both prediction and preferred method of identification, depending on e.g.:
level of concern for the user,
likelihood of incidents,
disabilities disabling certain alarm methods (blindness, deafness, etc.),
user capability to give reasonable identifications of predictions,
willingness to handle surplus alarms (false alarms), and
willingness of the caretakers to handle surplus alarms (false alarms).

For each user, it may be possible manage personal information and system set-up information, such as e.g.:
identification of the user,
identification of the user's gateway, including functionality to set up the gateway,
devices worn by the user, including functionality to set up the device,
certificates related to the user, including functionality to manage the certificates,
list of caretakers, including functionality to manage the list,
record voice messages for a pre-defined set of alarms, including functionality to record and manage messages,
location boundaries, including functionality to set up one or more geofences,
device and gateway status, including functionality to restore/manage these,
external sensors, including functionality to set up and manage external sensors,
networked parameters, including functionality to connect and manage networked parameters, and
home or residence automation systems, including functionality to set up and manage the connection with the automation system.

Users and managers may be granted access to monitor received and analysed data according to their authorization. A device user's relative may e.g. be given access to only alarms triggered, while the device user's doctor may see streams of sensor measurements and a researcher may be granted access to see aggregated statistical data for part of or the whole population of users.

It may also be possible for a user or a manager to log into the system to e.g. review the list of predictions and indications. The user may confirm or reject indications there through.

A wearable/portable health monitoring and coaching device may comprise a power source, one or more sensors, user feedback device/channel and a display.

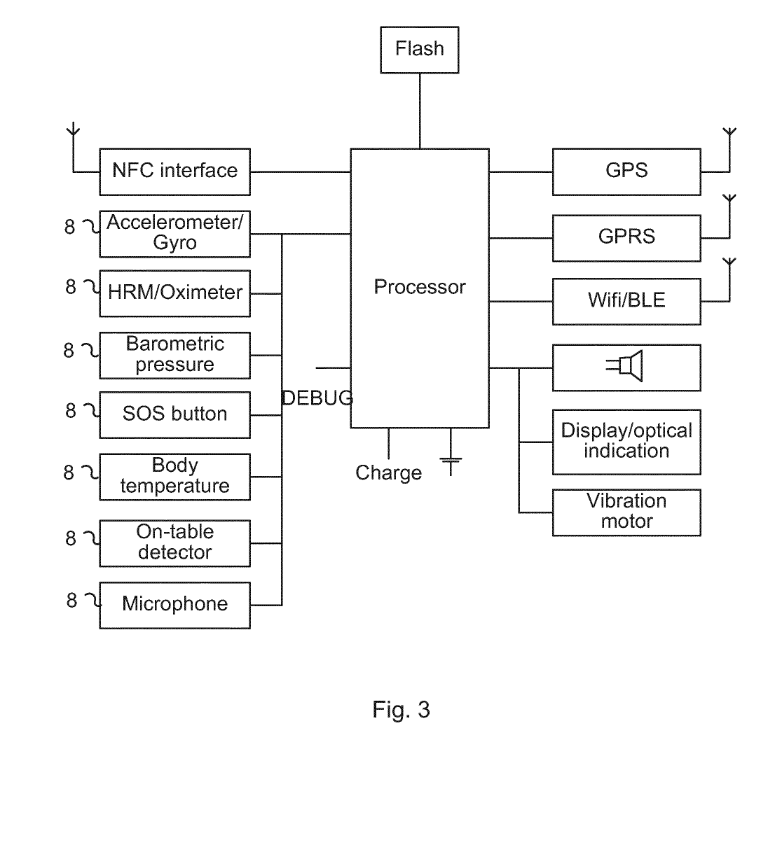

In an embodiment illustrated in FIG. 3, the wearable device comprises a processor with a flash memory. The processor is connected to an NFC interface, an accelerometer/gyro, a heart rate monitor/oximeter, a barometric pressure meter, a SOS button, a body temperature meter, an on-table detector, a microphone, a GPS receiver, a GPRS transceiver, a wifi/BLE transceiver, a speaker, a display/optical indicator, and a vibration motor.

Charging of a power source is preferably contact-free charging, such as inductive charging. A charging location may e.g. be arranged in a chair/sofa arm rest, or in other suitable charging locations, such as a kitchen table, or through a portable charging tray. Short time charging, may also be implemented, such that it is only is a matter of seconds each charging time. The charging may further be a wireless charging e.g. via an NFC antenna. Solar cells in the front glass, kinetics through normal use/activity generates power, battery pack in belt or pocket, battery packs located in or on a bracelet of the wearable device are further possible power sources. Small battery cells may be provided in a watch bracelet, cells may be swapped while the watch is running to ensure continuous power, and extra cells may be charged in a charger module and ready for swapping when the watch indicates drop in power level.

The sensors may be for measuring heart rate, blood oxygen saturation, sudden moves or G-forces, barometric pressure difference, and use or not use. An IR-based heart rate sensor can measure the heart rate continuously, i.e. measured at high enough, yet adjustable, frequency suitable for monitoring health related heart rate deviations. An IR-based blood oxygen saturation sensor can contribute to calculate health related hazards where low blood oxygen level—on it's own or in combination with other sensor readings—may trigger alarms. An accelerometer and gyro combination may be used to measure movement in any form. Both normal human movement—i.e. walking—as well as critical—at least for elderly people—movement like falling and other sudden moves that involves G-forces, which indicates health risk, may be measured. By monitoring arm movements, an epileptic attach may e.g. be determined. Similarly, other movement parameters may be used to predict a fall. In combination with a barometric sensor it is possible to detect a fall—even if the fall is slower than how a younger person would fall. A skin temperature may be measured continuously by e.g. IR and may be analysed either alone or in combination with other above mentioned sensor readings. An unwanted skin temperature or a skin temperature in combination with other sensor readings may trigger alarms. Barometric pressure, relative, not absolute, may, possibly in combination with other sensors and parameters such as location for lifts, escalators, etc., be used for fall detection. A barometric sensor is typically designed as a mini membrane in a capsule with hole(s) in it. An IR-sensor can detect if a watch is removed from the wrist and may trigger an alarm visible for care takers/dependants or for the user, reminding him/her to put the watch back on. This “on-table” function allows a watch to be used as an ankle monitor in the field of atonement, rehabilitation and aftercare.

Ultra sensitive sensors may be used to measure heart rate or even breathing of persons in a room. This can be e.g. radar based, contact-less sensors, networked to the safety feedback system. Autonomous bio sensors, which e.g. can be injected into blood veins, swallowed and then measure and send info while in the digestive system may be used. Also sensors attached to the body, such as ECG sensors and the like, may be used. Real time transmissions may be used, or measurements may be logged in a sensor for transfer to a monitoring system later on. Autonomous bio sensors may e.g. measure glucose, skin moisture indicating stress, fear, or panic, ECG and blood pressure. The measurements may also be made from implants such as pacemakers and similar devices.

Voice messages, including user recorded messages, may be used to calm down user and reduce stress level. The messages may be from relatives or dependents. An automatic connection to caretaker/dependents may be used. Sound, vibration or other tactile feedback, like electrical pulses, moving pins, etc. may be used to warn the user. Also visual feedback, such as symbols flashing on a screen may be used. A display may be of an e-paper technology display type, having low power consumption, black & white display, being clear and crisp regardless of surrounding light (even sunlight). Further, flashing symbols/lights in combination with sound and/or vibration may be used for alerting a user.

A more advanced gateway may e.g. be used in a user's home, which is illustrated in FIG. 2. When user is at home the watch 1 may easily upload sensor data to a cloud service 3 via a home gateway 4. The home gateway 4 may be connected to the internet via broadband with cellular data as backup. In addition the gateway may have several wired or wireless communication possibilities to be able to control home automation devices like door locks 5, light switches and dimmers 6, heating 7, security devices and more.

An application may be run on smartphones, tablets or web, to keep an eye on a user and/or to have an overview showing several users at the same time. The user himself/herself may of course use the application to stay updated on sensor readings and health status. The application may also offer control for smart home devices that are installed in the user's home and included in the safety feedback system.

Home automation may e.g. comprise control of light, heating, locks, video surveillance or other housing sensors.

Medical sensors may comprise medical measuring equipment or other medical equipment. The medical equipment may comprise pill dispensers, and presence sensors such as pressure sensors and motion detectors.

The gateway and the watch may be paired as part of a set-up process. By paring the watch with the gateway it is possible to identify the user's device and tie it to a users account in a central database, to set up a safe connection between the watch and the gateway, and to set up a safe connection between the watch and a central database when using long-distance communication (cellular data, open wifi networks, etc.).

During a pairing session, the gateway may transfer certificates, encryption keys, etc. and authenticate the watch to the relevant account. This enables safe, encrypted communication all the way from device through to the multi-user database. It does also enable the same safety both when communicating from the device via the gateway and from the device via public networks (Wi-Fi, GPRS, etc.)

Pairing may use cables or wireless connection. An example of such a wireless connection is NFC (Near Field Communication). This protocol ensures that the physical device is in immediate vicinity of the gateway, which reduces the risk of fraud.

NFC based pairing is a touch-to-pair process, where two devices recognizes each other and trigger the connection set up. This makes it possible for non-technical personnel to install, maintain and even service swap units.

Especially for users with dementia, it is important that the device is worn. Therefore, the bracelet may be equipped with means to prevent removal. A locked device, i.e. not possible to open without a key or a software key or command from internet or gateway, would likely require legal enforcement to apply to any user. A childproof lock, i.e. not forced locking, but designed to be difficult to operate, and thereby unlikely to be unlocked by a user may be used.

The solution is designed to become continuously more and more accurate in prediction and detection of health incidents. Used as a safety feedback system, it will in addition contribute to establish facts and patterns determining early phases of a potential fall, and utilize this knowledge to improve predictions and alerts both for the user and for the population of users. It will also learn which new combinations of measured parameters that should cause the alarm/warning to go off.

The safety feedback system will in the start only contain generic information about e.g. falls and their causes. Upon start-up, the wearable device may download the latest prediction and detection algorithms available. Hence, it will in the start only predict falls caused by health conditions where the triggers are generalized across the population of users. The user or his caretakers may adjust the sensitivity of both prediction and detection, depending on e.g. level of concern for the user, likelihood of incidents, type of health condition, willingness to handle false alarms, etc.

Over time, the device will learn more and more about the behaviour of the user, by receiving verification information about the alerted incidents.

The safety feedback system may also automatically extract and store information about the pre-incident parameters. The safety feedback system may search for patterns or correlations in and between available parameters during a pre-defined interval prior to an incident (typically 15, 30, 60, 120 seconds). Any such pattern/correlation may be stored for future use and sent to a central server together with incident data and post-incident data.

The safety feedback system may also in the same way perform the same searches across a full data set from the whole, or part of, population of data received from all users using a device connected to the central server. The occurrence of an incident for one user might be too small to derive a pattern or correlation. However, over the entire population of users, the statistical data will become large enough to produce significant indicators to determine correlations/patterns and thereby derive e.g. improved parameter threshold values. It will also be possible to identify types of causes and root causes. As a spin-off, this will significantly contribute to the characterization of both root causes of a fall, and to early indicators of falls and other acute incidents. This cross-population learning process might take place in the device or in the central database.

All prediction and detection methodologies will be coded as algorithms for use locally by the device. These methodologies, or at least relevant parts of them, may be force-downloaded to all or a selection of user devices, to improve the devices ability to predict and detect acute incidents. The download and potential reboot will be automatically managed and performed in a time of day where there is low user activity, such as during sleeping hours for the user. The download may be monitored, and perform a validation prior to acknowledging an update. If an acknowledgement is not given for any reason, the version is rolled back to the last known working version, and an alert may be sent as an error back to the safety feedback system. The device will then be able to predict and detect incidents both on a general or global basis, and on a personal or local basis. General prediction/detection methodologies may thus be both personalized and localized for each individual, by comparing global algorithms with local normal patterns and threshold values.

Over time, new algorithms will be manually or automatically qualified by the safety feedback system prior to being released, deployed and downloaded, and as algorithms are deployed in the safety feedback system, the prediction for a user will improve and be more accurate. Algorithms may e.g. be qualified qualitatively by a subject matter expert and/or be qualified quantitatively statistically. Any number of patterns/correlations can be extracted and deployed. If the safety feedback system has received information about the type of illness a user is suffering, the safety feedback system can focus the search for relevant patterns/correlations to a more relevant selection of parameters and combinations of these. For an optimal evaluation and characterization of prediction/detection triggers and patterns, each user can be registered with e.g. physical parameters, such as sex, age, weight, height, localization, such as country, area, health condition, illnesses, and medications.

The learning process might take place in the device or in the central database.

An approval process for releasing/launching new qualified algorithms may be added.

A process of having predictions and corresponding detections verified, may be applied in several ways.

A user or a caretaker can review a log of incidents, or review a single incident when or shortly after it takes place, and classify them/it to further improve future interpretation of sensor data. A simple confirmation to whether the incident was real or not, e.g. fall or not fall, is the simplest level of learning. An even better confirmation would be to answer one or more questions about the incident, typically related to the parameters and the outcome. It will also be possible to determine the requested feedback, both content and feedback methods, based on the type of incident, and/or based on the illness or health condition the user is set up with.

For some types of incidents, it will be possible for the device to automatically derive a verification from the subsequent parameter readings. If a user e.g. remains laying still with a low pulse over a longer period of time, and with a steadily decreasing body temperature, it is e.g. safe to assume the incident was real. Many such conditions which may derive a safe verification of incidents exist. More can be established over time by analysing the entire population of users, and download this to the device.

The user may confirm the incident (it took place) or reject the incident (false warning) directly at the watch.

A user may ignore a request for verification despite reminders from the device. In this case, the interpretation might depend on several parameters, where the type of incident together with sensor data determines the interpretation. Lack of response may mean either a healthy or an immobilized user.

A user should be able to stop future alarms of a certain type by providing feedback of false warnings.

Methods to provide verification may e.g. comprise a hand/arm gesture, such as thumb up/down, a voice command, pressing on buttons, physical or touch screen, or a web portal. The gesture may be detected by gyroscope and/or accelerometer measurements.

For fall prediction and detection, and other health condition monitoring, identifying and extracting patterns/correlations and algorithms for incidents may comprise one or more of the following analysis: comparing parameters towards threshold values, comparing parameters towards threshold values over a time window with respect to rate-of-change, comparing parameters towards threshold values over a frequency spectrum (e.g. Fourier transformed data) with respect to occurrence of frequencies (specific frequencies, peak frequency, sum of frequencies, superimposed frequencies, etc.), amplitude for any frequency or frequency ranges, or a combination thereof, comparing parameters instantaneously, over a time window or over a frequency spectrum, deviation between parameters, comparing parameters with each other over time with respect to deviation, correlation, variance, convergence or divergence, combine parameters by adding, subtracting, multiplying, dividing or other mathematical or logical operations performed on two or more parameters to produce new, combined parameters, wherein the selection of parameters and mathematical/logical operations may be random, to potentially detect hidden or arbitrary patterns, based on a thesis, or based on common, public knowledge, patterns may be derived from parameters or combinations of parameters with respect to use pattern recognition, digital signal processing, compression algorithms (mandrel, etc.), to recognize patterns in a signal, between signals or in combined signals, e.g. sinusoidal effects, logarithmic effects, repetitions, or extract information from a pattern such as max/min values, geometrical figures/components, formulas to describe a pattern, approximations of formulas to describe a pattern.

The term parameter is used for all kinds of information made available to the analysis process. It can be, but is not limited to, physiological sensor data on-board the device or remotely connected via line, bus or network, psychological sensor data on-board the device or remotely connected via line, bus or network, environmental (context) sensor data on-board the device or remotely connected via line, bus or network (e.g. weather data from internet), home automation sensor data on-board or remotely connected via line, bus or network, position/location data on-board or remotely connected via line, bus or network, GIS data (geographical information system) on-board or remotely connected via line, bus or network.

The solution may use all the above sensors, parameters, and resulting parameters and values to detect and/or predict incidents, referenced as triggers. A trigger is constituted by any of the above sensors, parameters, analysis methods and results. A trigger may also be a signal (hardwired, by bus or network) from other means of detection, e.g. an impact sensor indicating a quick deceleration, a manual and automatic trigger signal from a web based function, etc.).

The solution is designed to alert a user and possible a caretaker as early as there is confidence in the triggers (sensitivity is adjustable), and in any case after the occurrence of a fall. Prior to a fall can be as close as 1 second prior to a predicted fall, 5 seconds prior to a predicted fall or 60 seconds prior to a predicted fall, depending on significance of triggers.

The triggers may be evaluated for prediction/detection with reference to other parameters, which may amplify or degrade the significance of the trigger, such as activity (sleeping, exercising, eating), other sensor parameters (e.g. ambient air temperature and humidity), time of day and location.

One aspect to consider when analysing triggers is to compare with benchmarked normal activity. The safety feedback system may for each user automatically establish benchmarks for normal activities, like heart rate, blood oxygen level, time of day, etc. during recognized activities such as sleep, walking, jogging, running and other routine activities.

This may include recognition of slowly drifting parameters, which might indicate a slow change in health condition. A slow change can mean over hours, over days, over months or over years.

It may also include common knowledge combinations of parameters, known to be unhealthy or threatening in general or for a specific condition.

Fall prediction may use motion sensors, gyros, hart rate monitoring, blood oxygen monitoring and temperature monitoring. Particularly a combination of oxygen measurements and pulse measurements may be used to predict a fall.

A fall-detection algorithm using a 3-axis acceleration in combination with simple threshold and Hidden Markov Model may be used. To detect a fall, five types of parameters are used in the analyses. The fall-feature parameters of sum vector magnitude (SVM), differential SVM (DSVM) of acceleration, angle, gravity-weighted SVM (GSVM), and gravity-weighted DSVM (GDSVM) are calculated using the following equations:

$${A}_{SVM} ( i ) = \sqrt{{A}_{x}^{2} ( i ) + {A}_{y}^{2} ( i ) + {A}_{z}^{2} ( i )} , \\ θ ( i ) = {tan}^{- 1} ( \frac{\sqrt{{A}_{y}^{2} ( i ) + {A}_{z}^{2} ( i )}}{{A}_{x} ( i )} ) \times \frac{180}{π} , \\ {A}_{DSVM} ( i ) = \sqrt{{( {A}_{x} ( i ) - {A}_{x} ( i - 1 ) )}^{2} + {( {A}_{y} ( i ) - {A}_{y} ( i - 1 ) )}^{2} + {( {A}_{z} ( i ) - {A}_{z} ( i - 1 ) )}^{2}} , \\ {A}_{GSVM} ( i ) = \frac{180}{π} \times {A}_{SVM} ( i ) , \\ {A}_{GDSVM} ( i ) = \frac{180}{π} \times {A}_{DSVM} ( i ) ,$$

where i denotes the sample number and x, y, and z denote the x-axial, y-axial, and z-axial accelerations of the i-th sample, respectively. The Euler angle (θ) denotes the tilted angle between the accelerometer y-axis and the vertical direction.

Atrial fibrillation is a condition which does not necessarily represents a hazard to the user. However, it can represent a hazard, and it can represent discomfort. Atrial fibrillation is an abnormal heart rhythm characterized by rapid and irregular beating. Often it starts as brief periods of abnormal beating which become longer and possibly constant over time. Most episodes have no symptoms. Occasionally there may be heart palpitations, fainting, shortness of breath, or chest pain. The disease increases the risk of heart failure, dementia, and stroke.

Repetitive occurrences can indicate more serious conditions, and preventive actions can be done by medication and/or surgery. It is therefor of interest to measure, log and alert about atrial fibrillation. Oxygen measurement and pulse measurements may be used to monitor atrial fibrillation. It may be improved with extra sensors measuring wavelength/frequency over distance. A sensor may be applied to the chest or to the other arm compared to the one wherein the watch is worn and enable measurement of wavelengths and frequency. In one embodiment, the other sensor may be a second device of same type as disclosed herein, e.g. worn on the other arm.

Many health conditions/illnesses have a fixed or relatively fixed set of symptoms which with higher or lower degree of precision determines a diagnosis. These symptoms may be derived from parameters monitored by the safety feedback device/system. The safety feedback system can be set up to monitor one or more known health condition and warn the user accordingly.

The safety feedback system/device is not a medical diagnostic device, but a warning from it may be used to urge the user to see a doctor and in particular ask for an evaluation of the condition the safety feedback system/device has warned about.

Also, the safety feedback system may be set up to warn a user's doctor or caretaker immediately, and let him/her take action if deemed necessary.

The safety feedback system data may potentially be used as evidence in a case between the user and e.g. doctor or insurance company, e.g. in a dispute over correct evaluation, judgement or handling of the observation by the doctor. This can be compared to have a dashboard camera in your car or on your bike to document other party's behaviour and action in the traffic.

By wearing the device, a user has got full opportunities to have a home automation system that may operate completely and only based on input from the device via the gateway. The gateway will know the whereabouts of a user, and can automatically e.g. turn on/off lights, turn on/off heating/cooling, open/lock door locks, and disable dangerous circuits (coffee machine) when a user leaves the house.

An alarm signal is triggered by measurement(s) of certain health related parameters of a user, such as pulse/heart rate, blood oxygen level, and skin temperature.

The safety feedback system uses a feedback process in order to correct/improve the predetermined values which are to cause the alarm to go off. The feedback is in the form of an indication of if a fall actually has occurred or not. The indication may be in the form of a verification from a user and/or care person that the alarm in fact was for a fall or that it was not for a fall, i.e. a false alarm. The indication may also/alternatively be in the form of a confirmation through parameter readings whether the alarm was correctly issued, or if it was a false alarm. A verification and a confirmation may further comprise a factor of likelihood or the relevance of the feedback. A verification from a doctor may e.g. be provided with a higher relevance than a confirmation from a sensor value of a parameter reading.

The safety feedback system warns the user and/or a care person prior to a potential incident.

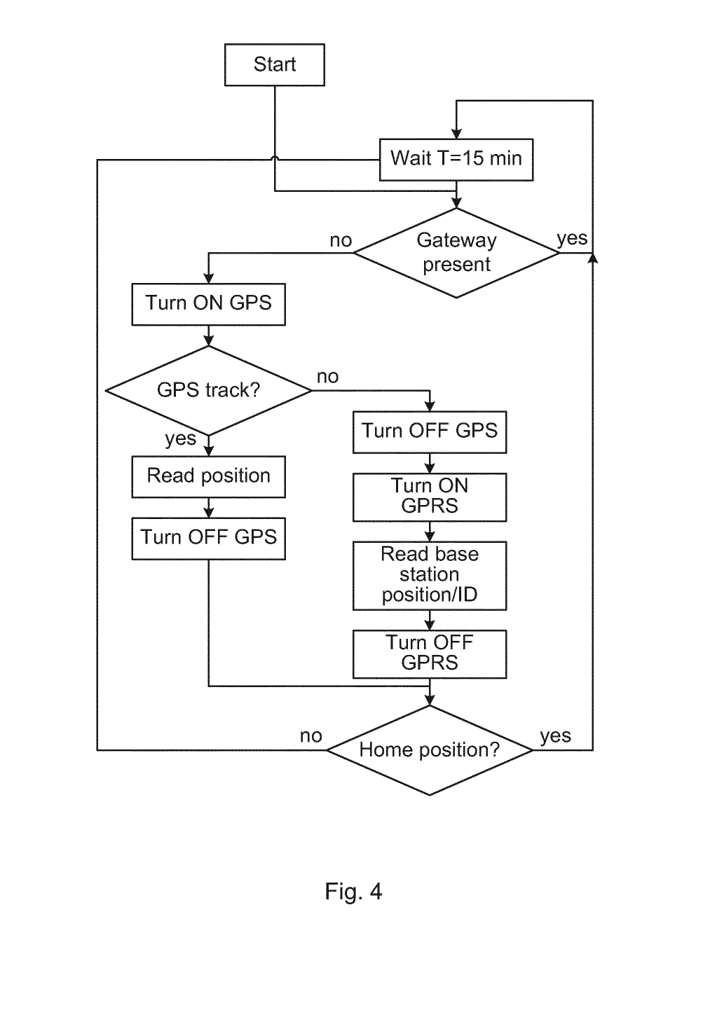

A procedure for tracking of the wearable device is illustrated in FIG. 4. The wearable device tries to connect to the home gateway. If the wearable device can connect to the gateway, it is in a home position, and will delay a period of time (e.g. 15 minutes) before a connection to the gateway is tried. If no gateway can be detected, a GPS receiver is activated. If GPS tracking is possible a geographical position is read and the GPS receiver is deactivated. If GPS tracking is not possible, the GPS receiver is deactivated and GPRS is activated instead. Abase station position/ID is read and the GPRS is turned of Based on either the GPS position or the base station position it is determined if the wearable device is at the home position or not. The wearable device will identify the home or away position after the delay period (e.g. 15 minutes). Tracking through GPS or GPRS may be made e.g. every 4 minutes to determine a route. Tracking may also be activated when a care person wants to find out where the user is located. Tracking is also activated when an alarm is activated. These tracking situations may be configurable, e.g. via an app/portal, as there may be users who do not want to reveal their location.

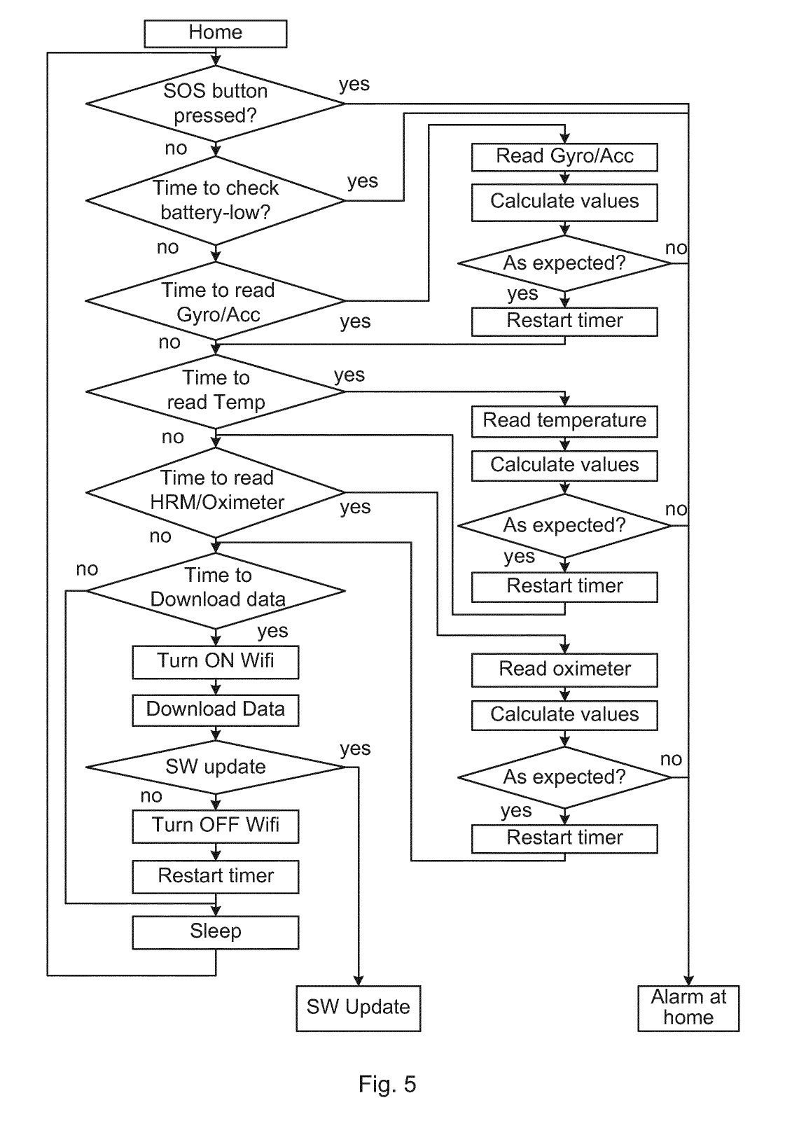

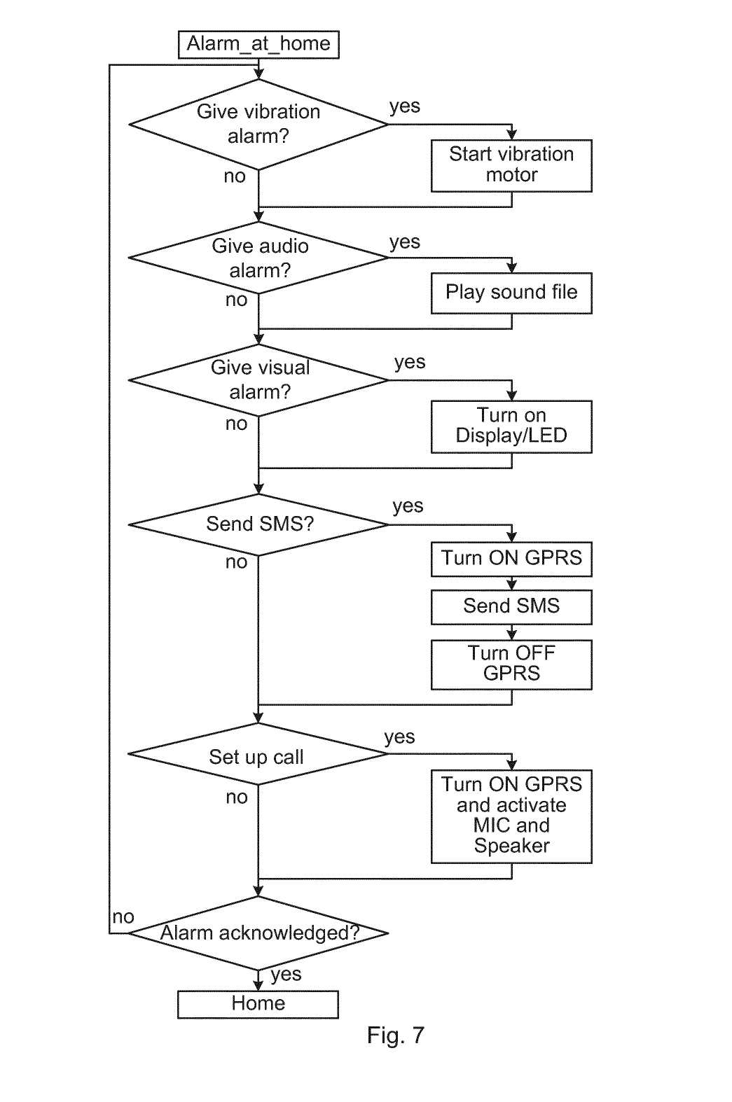

A procedure for managing the wearable device, when at home is illustrated in FIG. 5. If an SOS button is pressed, an alarm at home process is activated, illustrated in FIG. 7. Next, if it is time to check and if battery power is low, the alarm at home process is activated. Next, if it is time to read gyro/accelerometer, the gyro/accelerometer is read and the values calculated. If the values are not as expected, the alarm at home process is activated, and otherwise a timer is reset for when to again read the gyro/accelerometer. Next, if it is time to read temperature, the temperature is read and the values are calculated. If the values are not as expected, the alarm at home process is activated, and otherwise a timer is reset for when to again read the temperature. Next, if it is time to read hrm/oximeter, the hrm/oximeter are read and the values are calculated. If the values are not as expected, the alarm at home process is activated, and otherwise a timer is reset for when to again read the hrm/oximeter. Next, if it is time to read external data, the external data are read via network, and the values are calculated. If the values are not as expected, the alarm at home process is activated, and otherwise a timer is reset for when to again read the external. All calculation steps may take into account measurements and results generated by preceding steps in the process or one or more preceding cycles. Next, if it is not time to download data, the wearable device is put into sleep mode, otherwise wifi is turned on and data is downloaded. The sleep mode may be configurable from milliseconds to seconds, or even minutes. If a software update is present a software update is made (directly or at a later time/more convenient time for the user) and the process is restarted, otherwise the wifi is turned of and a timer is reset for when to again download data. The wearable device is thereafter put into the sleep mode.

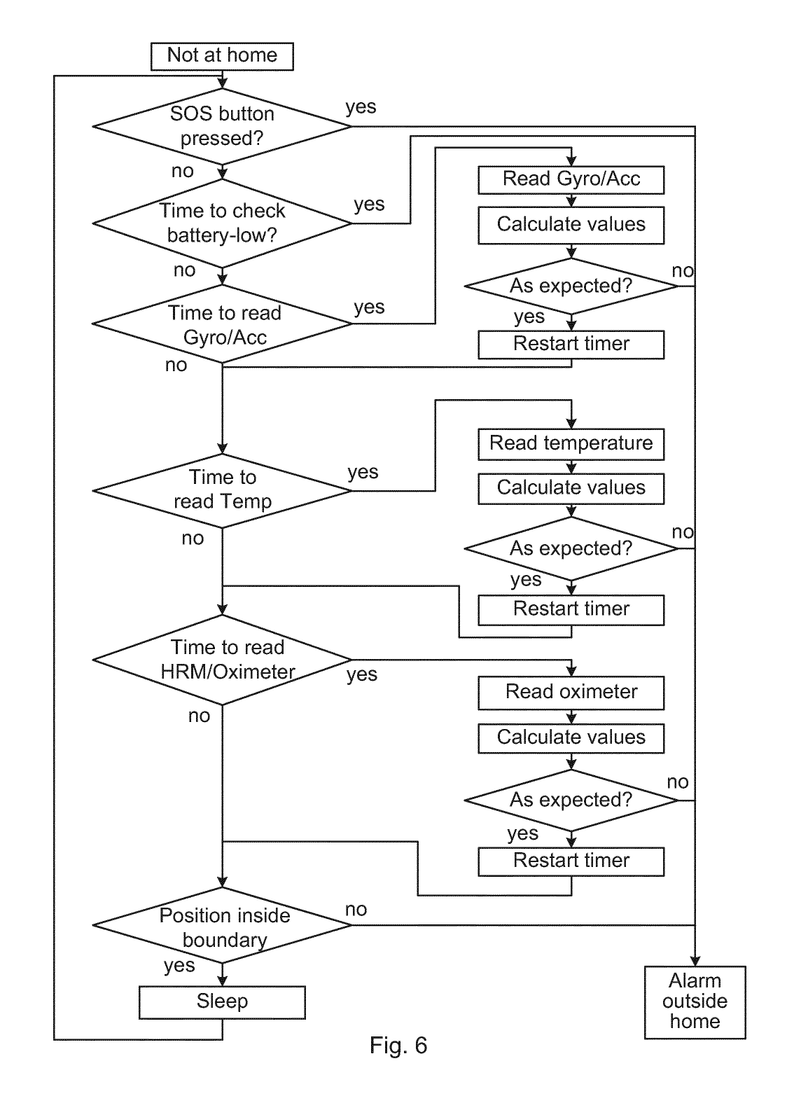

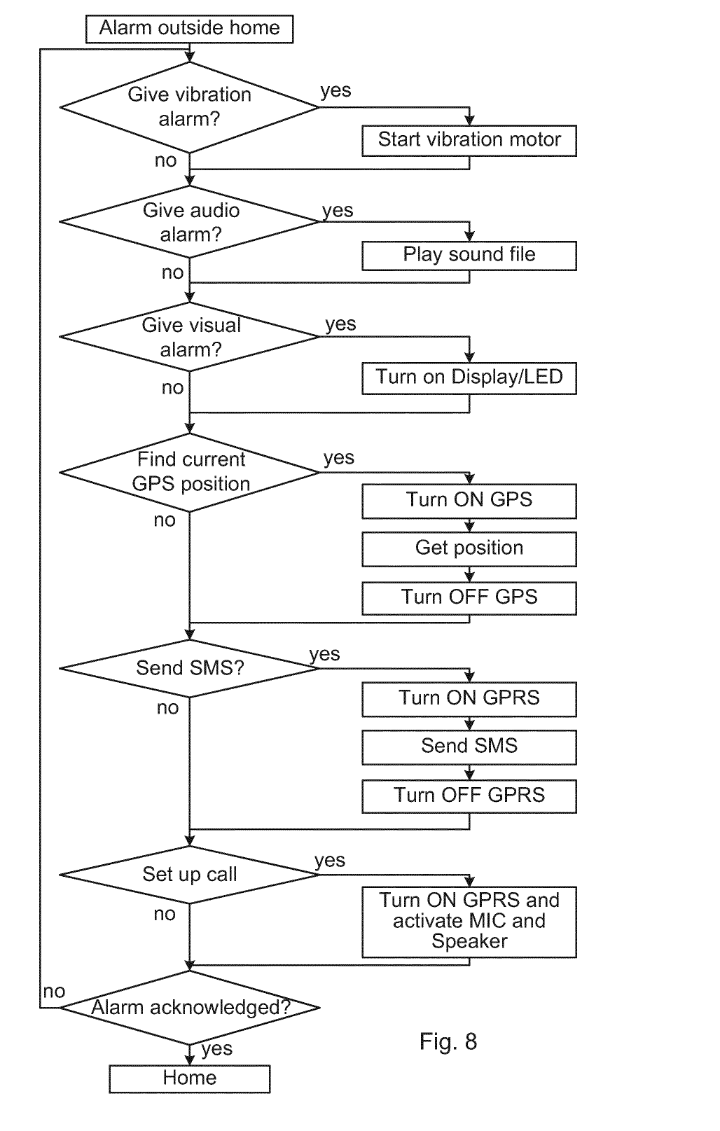

A procedure for managing the wearable device, when not at home is illustrated in FIG. 6. If an SOS button is pressed, an alarm outside home process is activated, as illustrated in FIG. 8. Next, if it is time to check and if battery power is low, the alarm at home process is activated. Next, if it is time to read gyro/accelerometer, the gyro/accelerometer is read and the values calculated. If the values are not as expected, the alarm outside home process is activated, and otherwise a timer is reset for when to again read the gyro/accelerometer. Next, if it is time to read temperature, the temperature is read and the values are calculated. If the values are not as expected, the alarm outside home process is activated, and otherwise a timer is reset for when to again read the temperature. Next, if it is time to read hrm/oximeter, the hrm/oximeter are read and the values are calculated. If the values are not as expected, the alarm outside home process is activated, and otherwise a timer is reset for when to again read the hrm/oximeter. Next, it is checked if the wearable device is inside a boundary (home or other boundary). Another boundary may be for each user or for a group of users, or time dependent apart from geographically dependent. The wearable device is thereafter put into the sleep mode.

The procedure for managing the alarm at home is illustrated in FIG. 7. If the wearable device is configured to give a vibration alarm, a vibration motor is started. Similar configurations may be made for each alarm/condition, such as sound, light, etc. Next, if the wearable device is configured to give an audio alarm, a sound file is played or tones are generated. Next, if the wearable device is configured to give a visual alarm, a display/LED is turned on. Next, if the wearable device is configured to send an SMS, the GPRS is turned on, the SMS is sent, and the GPRS is turned off. Next, if the wearable device is configured to set up a call to a person defined in a list of caretakers, GPRS is turned, the mic and speaker are activated, and a call is made according to the list of caretakers. If the call is not answered, the next person in the list is called. Further (not illustrated), if the wearable device is configured to detect an incoming call, GPRS is turned on and mic and speaker are activated. The device can be configured to allow for this automatic connection of incoming calls if the calling number is listed in the caretaker list. Next, if the alarm is not acknowledged, the process restarts. Otherwise, the home process is restarted. Further (not illustrated), the wearable device may be configured to upload data to the central database via the home gateway, e.g. for each cycle of the home process.

The procedure for managing the alarm outside home is illustrated in FIG. 8. If the wearable device is configured to give a vibration alarm, a vibration motor is started. Next, if the wearable device is configured to give an audio alarm, a sound file is played. Next, if the wearable device is configured to give a visual alarm, a display/LED is turned on. Next, if the wearable device is configured to find PGS position, GPS is turned on, position is retrieved, and GPS is turned of. Next, if the wearable device is configured to send an SMS, the GPRS is turned on, the SMS is sent, and the GPRS is turned off. Next, if the wearable device is configured to set up a call to a person defined in a list of caretakers, GPRS is turned on and mic and speaker are activated. Further (not illustrated), if the wearable device is configured to detect an incoming call, GPRS is turned on and mic and speaker are activated. Next, if the alarm is not acknowledged, the process restarts. Otherwise, the home process is restarted. Further (not illustrated), the wearable device may be configured to check if its memory is full and then upload data to the central database via e.g. GPRS, otherwise it will wait to upload data unit at home again.

The procedures described above may be operating system free, and have simple and single thread execution in sequence, but may also be supplemented with hardware triggers to handle immediate requests. Examples of hardware triggers may e.g. be hardware recognition of fall and an alarm button.

A method for fall warning is presented with reference to FIG. 11A. The method is performed by a wearable device 1 and comprises measuring 20 at least one physiological parameter of a user wearing the wearable device 1, predicting 22 a fall of the user, by comparing the measured at least one physiological parameter with a threshold, warning 23 the user when a fall is predicted, receiving 24 an indication of a fall or of not a fall for the predicted fall, and adjusting 25 the threshold based on the received indication.

The at least one physiological parameter may comprise blood oxygen saturation.

The method may, as illustrated in FIG. 11B, further comprise measuring (21) a second parameter, different from the at least one physiological parameter of the user, to provide the indication of a fall or not a fall. The second parameter may be a relative barometric pressure.

The method may comprise receiving a list of indications of a fall or of not a fall for a plurality of corresponding predicted falls. The indications may be provided by the user or a care person, shortly after a fall has been predicted, or at a later time when one or more indications have been evaluated. The indications may be provided by the wearable device being configured to read parameters and determining that a fall has occurred or not.

An embodiment of a wearable device is presented. The wearable device comprises a sensor configured to measure at least one physiological parameter of a user wearing the wearable device, a control unit configured to predict a fall of the user, by comparing the measured at least one physiological parameter with a threshold, and a user interface configured to warn the user when a fall is predicted, wherein the control unit is configured to receive an indication of a fall or not a fall for the predicted fall, and to adjust the threshold based on the received indication.

The sensor may be configured to measure blood oxygen saturation of the user. The sensor may be an optical sensor, preferably an IR sensor.

The wearable device may comprise a second sensor configured to measure a second parameter, different from the physiological parameter of the user, to provide the indication of a fall or not a fall. The second sensor may be a relative altitude sensor, measuring a relative barometric pressure.

The control unit may comprise a processor and a computer program product storing instructions that, when executed by the processor causes the wearable device to measure at least one physiological parameter of a user wearing the wearable device, predict a fall of the user, by comparing the measured at least one physiological parameter with a threshold, warn the user when a fall is predicted, receive an indication of a fall or of not a fall for the predicted fall, and adjust the threshold based on the received indication.

A computer program for fall warning is presented. The computer program comprises computer program code which, when run on a wearable device, causes the wearable device to measure at least one physiological parameter of a user wearing the wearable device, predict a fall of the user, by comparing the measured at least one physiological parameter with a threshold, warn the user when a fall is predicted, receive an indication of a fall or of not a fall for the predicted fall, and adjust the threshold based on the received indication.

A computer program product is presented. The computer program product comprises a computer program and a computer readable storage means on which the computer program is stored.

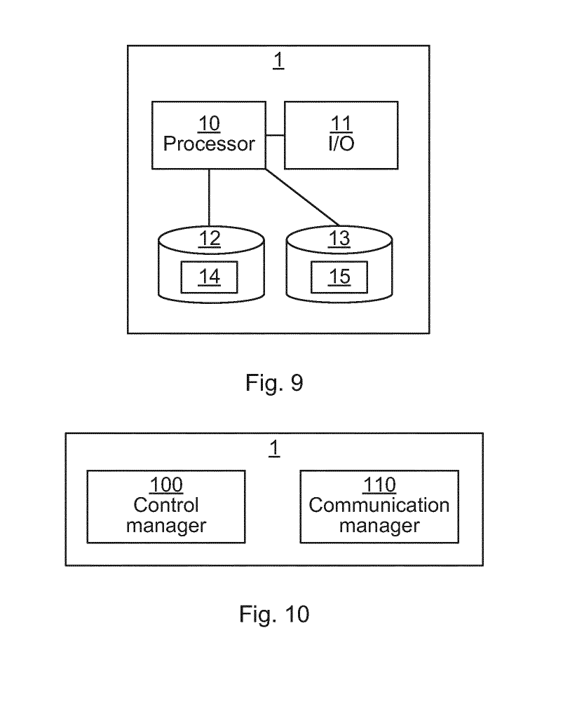

FIG. 9 is a schematic diagram showing some components of the wearable device 1. A processor 10 may be provided using any combination of one or more of a suitable central processing unit, CPU, multiprocessor, microcontroller, digital signal processor, DSP, application specific integrated circuit etc., capable of executing software instructions of a computer program 14 stored in a memory. The memory can thus be considered to be or form part of the computer program product 12. The processor 10 may be configured to execute methods described herein with reference to FIGS. 11A-B.

The memory may be any combination of read and write memory, RAM, and read only memory, ROM. The memory may also comprise persistent storage, which, for example, can be any single one or combination of magnetic memory, optical memory, solid state memory or even remotely mounted memory.

A second computer program product 13 in the form of a data memory may also be provided, e.g. for reading and/or storing data during execution of software instructions in the processor 10. The data memory can be any combination of read and write memory, RAM, and read only memory, ROM, and may also comprise persistent storage, which, for example, can be any single one or combination of magnetic memory, optical memory, solid state memory or even remotely mounted memory. The data memory may e.g. hold other software instructions 15, to improve functionality for the wearable device 1.

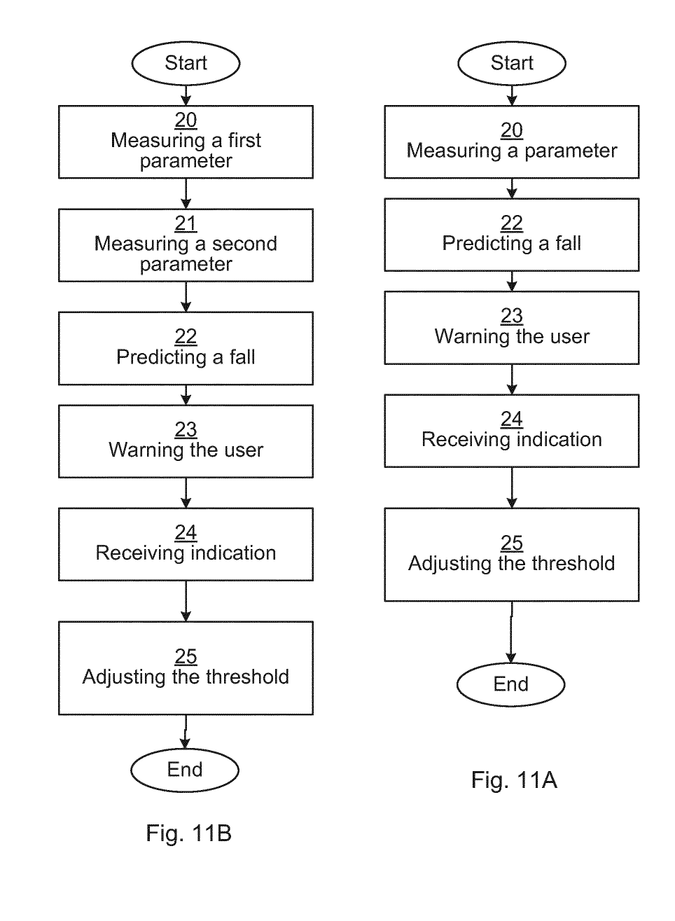

FIG. 10 is a schematic diagram showing functional blocks of the wearable device 1. The modules may be implemented as only software instructions such as a computer program executing in the cache server or only hardware, such as application specific integrated circuits, field programmable gate arrays, discrete logical components, transceivers, etc. or as a combination thereof. In an alternative embodiment, some of the functional blocks may be implemented by software and other by hardware. The modules correspond to the steps in the methods illustrated in FIGS. 11A-B, comprising a control manager unit 100 and a communication manager unit 110. In the embodiments where one or more of the modules are implemented by a computer program, it shall be understood that these modules do not necessarily correspond to process modules, but can be written as instructions according to a programming language in which they would be implemented, since some programming languages do not typically contain process modules.

The control manger 100 is for controlling the wearable device 1. This module corresponds to the measuring step 20, the measuring step 21, the predicting step 22, and the adjusting step 25 of FIGS. 11A-B. This module can e.g. be implemented by the processor 10 of FIG. 9, when running the computer program.

The communication manger 110 is for controlling the wearable device 1. This module corresponds to the warning step 23 and the receiving step 24 of FIGS. 11A-B. This module can e.g. be implemented by the processor 10 of FIG. 9, when running the computer program.

Steps for measuring physiological parameters described herein may be non-invasive, non-surgical, and may e.g. be performed by an optical device comprising an optic sensor.

The invention has mainly been described above with reference to a few embodiments. However, as is readily appreciated by a person skilled in the art, other embodiments than the ones disclosed above are equally possible within the scope of the invention, as defined by the appended patent claims.

1. A method for fall warning, the method being performed by a wearable device (1) and comprising:
measuring (20) at least one physiological parameter of a user wearing the wearable device;
predicting (22) a fall of the user, by comparing the measured at least one physiological parameter with at least one threshold;
warning (23) the user when a fall is predicted;
measuring (21) a second parameter, different from the at least one physiological parameter of the user, to provide an indication of a fall or not a fall for the predicted fall, wherein the second parameter is a relative barometric pressure or a user verification indication;
receiving (24) the indication of a fall or of not a fall for the predicted fall; and
adjusting (25) at least one threshold based on the received indication.

2. The method as claimed in claim 1, wherein the at least one physiological parameter comprises blood oxygen saturation and/or heartrate.

3. (canceled)

4. (canceled)

5. The method as claimed in claim 1, comprising receiving a list of indications of a fall or of not a fall for a plurality of corresponding predicted falls.

6. The method as claimed in claim 1, comprising playing a recorded message, when a fall is predicted.

7. A method for fall warning, the method being performed by a central server and a wearable device and comprising:
measuring (20), in the wearable device, at least one physiological parameter of a user wearing the wearable device;
predicting (22), in the wearable device, a fall of the user, by comparing the measured at least one physiological parameter with at least one threshold;
warning (23), in the wearable device, the user when a fall is predicted;
receiving (24), in the wearable device, a verification indication of a fall or not a fall for the predicted fall, based on a second parameter, different from the at least one physiological parameter of the user;
receiving, in the central server, fall data for a predicted fall of a user of a wearable device, from a plurality of wearable devices;
receiving, in the central server, verification indications of a fall or not a fall of the user of the wearable device, for falls predicted by the plurality of wearable devices;
providing, by the central server, an algorithm for predicting a fall, based on the received fall data and received verification indications;
downloading from the central server to a wearable device the algorithm for predicting a fall of a user of a wearable device; and
adjusting (25), in the wearable device, at least one threshold based on the received algorithm.

8. A wearable device (1), comprising:
a memory and a transceiver;
at least one sensor (8) configured to measure at least one physiological parameter of a user wearing the wearable device;
a second sensor (8) configured to measure a second parameter, different from the at least one physiological parameter of the user, to provide an indication of a fall or not a fall, wherein the second sensor is a relative altitude sensor, measuring a relative barometric pressure, or a sensor detecting a user verification indication;
a control unit (10) configured to predict a fall of the user, by comparing the measured at least one physiological parameter with at least one threshold; and
a user interface (11) configured to warn the user when a fall is predicted,
wherein the control unit is configured to receive the indication of a fall or not a fall for the predicted fall, and to adjust at least one the threshold based on the received indication.

9. The wearable device (1) as claimed in claim 9, wherein the at least one sensor is configured to measure blood oxygen saturation of the user and/or heartrate.

10. The wearable device (1) as claimed in claim 9, wherein the at least one sensor is an optical sensor.

11. (canceled)

12. (canceled)

13. The wearable device (1) according to claim 8, wherein, the control unit comprising:
a processor (10) and a computer program product (12, 13) storing instructions that, when executed by the processor causes the wearable device to:
measure the at least one physiological parameter of a user wearing the wearable device,
predict a fall of the user, by comparing the measured at least one physiological parameter with at least one threshold,
warn the user when a fall is predicted,
measure the second parameter,
receive the indication of a fall or of not a fall for the predicted fall, and
adjust at least one threshold based on the received indication.

14. A computer program (14, 15) for fall warning, the computer program comprising computer program code which, when run on a wearable device (1), causes the wearable device (1) to:
measure at least one physiological parameter of a user wearing the wearable device,
predict a fall of the user, by comparing the measured at least one physiological parameter with at least one threshold,
warn the user when a fall is predicted,
measure a second parameter, different from the at least one physiological parameter of the user, to provide an indication of a fall or not a fall, wherein the second parameter is a relative barometric pressure,
receive the indication of a fall or of not a fall for the predicted fall, and
adjust at least one threshold based on the received indication.

15. A computer program product (12, 13) comprising a computer program according to claim 14 and a computer readable storage means on which the computer program (14, 15) is stored.

16. The method according to claim 5, further comprising measuring a third parameter to improve the verification indication of a fall or not a fall, wherein the third parameter is a GPS location of the wearable device.

17. The method according to claim 5, wherein the predicting step comprises recognition of slowly drifting parameters.

18. The method according to claim 5, wherein the second parameter is a relative barometric pressure or a user verification indication.
